(19) United States
(12) Patent Application Publication
(10) Pub. No.: US 2002/0002537 A1
(43) Pub. Date: Jan. 3, 2002

(54) Simplified bill paying method

(76) Inventor: Richard Bastiansen, Raynham, MA (US)

Correspondence Address: Brian M. Dingman, Esq., Mirick, O'Connell, DeMallie & Lougee, LLP, 100 Front Street, Worcester, MA, 01608, US

(21) Appl. No.: 09/878,550

(22) Filed: Jun. 11, 2001

Related U.S. Application Data
(60) Provisional application No. 60/214,110, filed on Jun. 26, 2000.

(51) Int. Cl. G06F 17/60

(52) U.S. Cl. 705/40

(57) ABSTRACT

A simplified bill paying method transacted between a customer and a financial institution, comprising the customer determining payees to be included in the method; the financial institution providing to the customer a form with one listing per selected payee, including at least the payee name and a designated area to carry an amount to be paid to at least one such payee; adding into one or more of the areas the one or more amounts to be paid to the appropriate payees; and, in response to the filled-in amounts, at the direction of the financial institution, accomplishing the correct funds transfer to the appropriate payees.

### CROSS REFERENCE TO RELATED APPLICATION

This application claims priority of Provisional application serial No. 60/214,110, filed on Jun. 26, 2000.

### FIELD OF THE INVENTION

This invention relates to the processes of bill payment as performed by consumers, and a method for accomplishing this process.

### BACKGROUND OF THE INVENTION

Individuals traditionally write a single check, insert it in an envelope with a payment coupon and mail it to the designated payee. Preparing each check involves several writing steps which include, the date, payee's name, numeric amount, amount in script and a signature. Commonly consumers are required to enter an account number in the “Memo” area on checks. A “stub” is normally detached from the bill received and must be enclosed in the payment envelope to the payee. A stamp and return address should be entered on the face of the envelope. Each bill to be paid requires a repeat of these steps.

It has been the intention of the financial services, and now numerous electronic businesses, to migrate consumers to a simpler form of bill payment. These started with telephone bill payment services, moved to direct debit of consumer accounts, and have progressed to Internet bill presentment and bill payment services. It does not appear from publicly available data that any of these efforts have been successful. They have not been convenient for the consumer and have not provided value without loss of control.

### SUMMARY OF THE INVENTION

It is therefore a primary object of this invention to provide a simpler means for consumers to issue instructions to their financial institution to pay bills. The form, which is a major element of this invention, is intended to make the process of paying bills less time consuming, require less writing, require less physical activity such as writing checks, removing stubs, inserting several papers into an envelope and then repeating the process for each bill to be paid.

It is a further object of this invention to provide a method which will allow consumers to feel confident that their relationship continues with a financial institution.

It is a further object of this invention to provide consumers with a similar feeling of control as they currently have over the time at which they elect to pay a particular bill.

It is a further object of this invention to provide added value to the consumer who elects to use this service by providing a budget of major bills at the end of each year of use.

It is a further object of this invention to provide additional information of value to the financial institution in the form of consumer spending patterns in an electronic form suitable for analysis and marketing.

It is a further object of this invention to provide a significant incentive for consumers to move the checking account to a financial institution offering this invention to its customers.

It is a further object of this invention to reduce the number of checks written annually by consumers, and to further increase the volume of electronic bill payments, in an effort to strengthen the payment systems as developed by the financial institutions and the Federal Reserve System.

This invention features in one embodiment a method for individual consumers to issue to their financial institution a group of instructions to issue payments to selected payees from a predefined group of payees. The consumer will stipulate the amount to be paid to each payee. The financial institution will act upon the consumer's written instruction promptly and cause payments to be made from the customer's account by the most expeditious means available at that time. Payment may be made by electronic transmission via various available formats such as the Automated Clearing House (ACH) or any other electronic means acceptable to the payee. Payments may also be made using checks of the financial institution or any other form as appropriate and acceptable to the payee.

This invention features a simplified bill paying method transacted between a customer and a financial institution, comprising the customer determining payees to be included in the method; the financial institution providing to the customer a form with one listing per selected payee, including at least the payee name and a designated area to carry an amount to be paid to at least one such payee; adding into one or more of the areas the one or more amounts to be paid to the appropriate payees; and in response to the filled-in amounts, at the direction of the financial institution, accomplishing the correct funds transfer to the appropriate payees.

The method may further include, after accomplishing the funds transfer, the financial institution providing another form, and indicating on such form the most recent amount paid to each listed payee. The new form may also include the amount paid to each listed payee year-to-date.

The adding step may be accomplished at least in part by the customer, and at least in part by the financial institution. The method may further comprise categorizing payees into budget categories, and indicating such on the form. The method may still further comprise, after the end of a calendar year, the financial institution preparing for the customer a summary of the amount paid by the customer to each payee.

The method may also comprise the financial institution creating and maintaining customer payee information comprising a unique identifier for each payee of a customer. The customer payee information may further comprise a payee type code. The customer payee information may further comprise payee category information.

In a more specific embodiment, this invention features a simplified bill paying method transacted between a customer and a financial institution, comprising the customer determining payees to be included in the method; the financial institution providing to the customer a form with one listing per selected payee, including at least the payee name and a designated area to carry an amount to be paid to at least one such payee, and further comprising categorizing payees into budget categories, and indicating such on the form; adding into one or more of the areas the one or more amounts to be paid to the appropriate payees, wherein the adding step may be accomplished at least in part by the customer, and is accomplished at least in part by being printed on the form by the financial institution; in response to the filled-in amounts, at the direction of the financial institution, accomplishing the correct funds transfer to the appropriate payees; and after accomplishing the funds transfer, the financial institution providing another form, and indicating on such form the most recent amount paid to each listed payee, wherein the new form also includes the amount paid to each listed payee year-to-date.

### BRIEF DESCRIPTION OF THE DRAWINGS

Other objects, features and advantages will occur to those skilled in the art from the following description of the preferred embodiment, and the accompanying drawings in which:

FIG. 1 is a diagram of the process flow upon which the preferred embodiment described herein is based; and

FIG. 2 is a sample of the preferred form upon which the method of the invention is based.

### DETAILED DESCRIPTION OF THE PREFERRED EMBODIMENTS

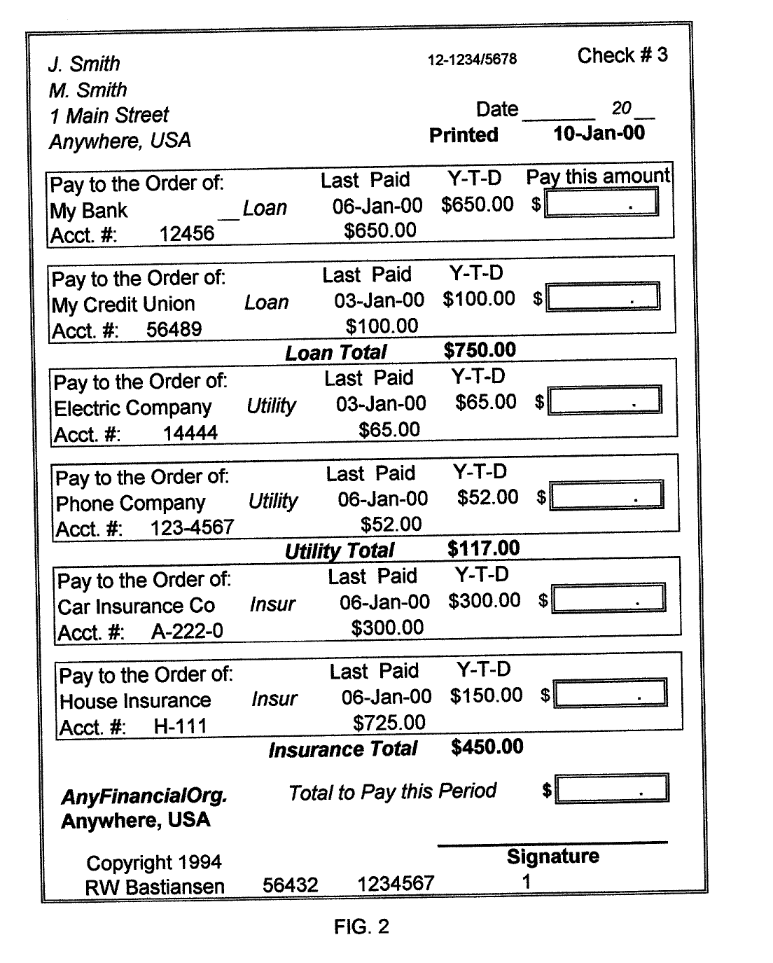

References in the diagram to the form are referring directly to the form, format, presentation, substance and content of the sample form shown in FIG. 2. This process flow includes all the steps described in the preferred embodiment that describe the ongoing interaction of the customer, the financial institution, the form and the method of payment generation.

The invention features a series of steps which both the consumer and financial institution will follow to establish a contractual relationship and to effect the execution of payment instructions. These steps are outlined as follows:

Consumer elects to utilize this service.

Consumer accepts disclosure of terms and conditions from financial institution.

Consumer provides to financial institution the name and address of each payee that they elect to include in the process. The address may be to a “lock box” provided by a financial institution for the purpose of accepting payments on behalf of the payee.

Consumer provides their account number with each of these payees to the financial institution to insure payment is credited to the consumer's account at the payee.

The financial institution may categorize payees into generally acceptable budget categories of loans, credit cards, utilities, insurance, etc.

The consumer may elect to add to this list of payees at any time by notifying the financial institution of an additional payee with proper notice time provided.

The financial institution provides the consumer with one form pre-printed with the customer's requested payees itemized.

Consumer determines time and place at which to initiate bill payment using the form. This may be weekly, bi-weekly, monthly or at any interval selected.

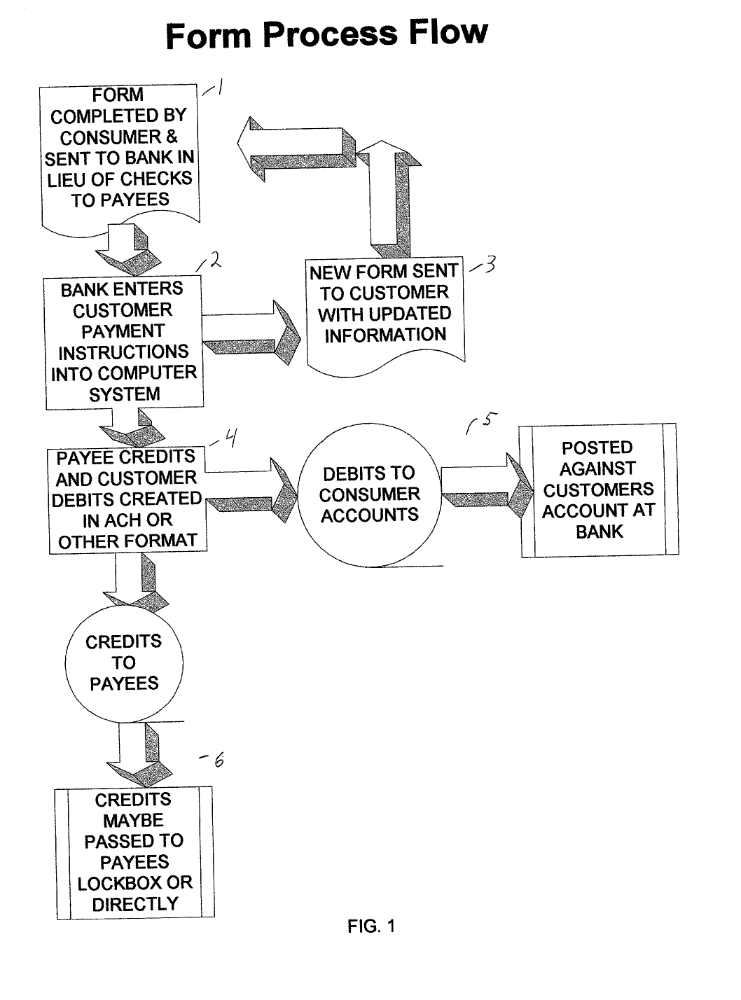

Consumer fills in date, amounts to be paid to selected payees, a total of all payments to payees, and signs the form in lieu of writing individual checks (FIG. 1, #1).

The consumer may enter into their checkbook register the individual entries made, or the total of all transactions as a single entry. The consumer's statement from the financial institution will show each transaction individually, and financial institutions will be encouraged to include a statement line item disclosing the sum of each transaction using the form.

Consumer forwards the completed form to their financial institution, or a servicer selected by their financial institution.

Using the account number from the customer's form, the financial institution personnel retrieve on a computer screen the same list of payees as depicted on the customer's form. Entries of the amounts written in by the consumer are repeated into the banks system. Once all entries are made the total of data entered amounts is compared to the total amount entered by the consumer. This completes the data entry portion of the process. (FIG. 1, #2).

The software provided to the banks for processing these transactions then prints a new form for this customer, with updated information such as the next sequential form number, dates and amounts of those payments processed in the preceding step, incremented totals of payments so far this year for those payments, and the same information carried forward for those payees not effected by these transactions. The form may be completely printed by the software, or be a pre-printed form with only the variable data printed by the software. (FIG. 1, #3).

The newly created form is immediately sent to the consumer for use the next time they elect to pay bills received from any of the vendors listed on their form.

The financial institution continues the process by periodically (at least once per day) requesting that the software generate debit and credit transactions to cause the customer's account to be debited for the amount of payments requested and credits be generated to the vendors selected by the customer. Transactions will be created in the Automated Clearing House (ACH) format as defined by NACHA (National Automated Clearing House Association). The format of these transactions may be altered or reformatted to accommodate the unique system requirements of each financial institution. (FIG. 1, #4 and #5).

The financial institution may select from several vendors available in the market place who provide bill payment services. The payment transactions can be forwarded to them for production of electronic payments, most are issued in the ACH format, or the production of checks which are mailed to the payees. The financial institution may elect to extract its own payments for loans, mortgages, etc. prior to this step. The financial institution may also elect to initiate some or all of the payments themselves. (FIG. 1, #6).

At the end of each year the software will reset its accumulators of payments made during the year. Historical information will be saved to allow the production of a summary or “budget” for each customer, and for analysis by the financial institution. This may include the amount paid over the course of the year to each payee. The software may allow exporting of all its accumulated information at any time.

The following is a description of the system components and functionality required to support this process.

A bank information file containing a unique identifier for each bank if more than one is using the software, the bank name, EIN, address including city, state and zip, ABA routing number, account number and type to be used for billing for this service, telephone number, last billed date and other information such as bank assigned product name.

A customer file containing the bank number, account type and number of the customer, name and address (including city, state, zip), payment counter, and other elements as necessary.

A customer payee file containing the bank number, customer account number at the financial institution, a unique item number assigned to this payee for this customer (for example, 1^{st}, 2^{nd}, etc.), payee type code (referring to broad budget categories such as “Insurance”), a sub-category code (referring to specific categories such as “Life Insurance”), payee bank's ABA routing number and account number at that bank, customer's account number with the payee, an amount field to accept each processing cycle's dollar input for forms received, date of last payment, amount of last payment, and amount paid to this payee this year.

A payee (or vendor) file containing the bank number of the financial institution, ABA routing number of the payee's account, account number of the payee at its financial institution, payee's name, address (including city, state, zip), and a flag indicating the method of payment that this payee will accept (i.e., ACH, check, other specific formats).

A file of payments made will be maintained in the software and will include details of every transaction processed.

A security file will be maintained which will determine the extent of access to software features for each operator of the software.

The software may contain a file summarizing the activity of each operator's activities while using the software including numbers of transactions, changes and detailed activity.

The following are the functions that the software will perform as requested.

Setting up of new financial institutions as users of the software. This will include accepting, validating and storing the information required in the bank information file mentioned above.

Setting up of new operators of the software in the security file as mentioned above, including accepting, validating and storing required information.

Setting up of new customers as customers request this service. This will include accepting, validating and storing the information required in the customer file and customer payee file mentioned above.

Setting up of new payees as requested by customers of this service. This will include accepting, validating and storing the information required in the payee file as mentioned above.

Accepting the input of information relative to each payment instruction received from a customer submitting a form to the financial institution, and posting this information to the customer payee file as mentioned above.

The extracting of payment information in a batch mode, or in a real-time mode, from the customer payee file and the creation of ACH files as described previously, or other format files as requested by the financial institution. This process will also create the payments file.

The software will also allow inquiry to historical information for the purposes of allowing financial institution to research payment status and history for customers as requested.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A simplified bill paying method transacted between a customer and a financial institution, comprising:
the customer determining payees to be included in the method;
the financial institution providing to the customer a form with one listing per selected payee, including at least the payee name and a designated area to carry an amount to be paid to at least one such payee;
adding into one or more of the areas the one or more amounts to be paid to the appropriate payees; and
in response to the filled-in amounts, at the direction of the financial institution, accomplishing the correct funds transfer to the appropriate payees.

2. The method of claim 1, further including, after accomplishing the funds transfer, the financial institution providing another form, and indicating on such form the most recent amount paid to each listed payee.

3. The method of claim 2 wherein the new form also includes the amount paid to each listed payee year-to-date.

4. The method of claim 1, wherein the adding step is accomplished at least in part by the customer.

5. The method of claim 1, wherein the adding step is accomplished at least in part by the financial institution.

6. The method of claim 1, further comprising categorizing payees into budget categories, and indicating such on the form.

7. The method of claim 1, further comprising, after the end of a calendar year, the financial institution preparing for the customer a summary of the amount paid by the customer to each payee.

8. The method of claim 1, further comprising the financial institution creating and maintaining customer payee information comprising a unique identifier for each payee of a customer.

9. The method of claim 8, wherein the customer payee information further comprises a payee type code.

10. The method of claim 9, wherein the customer payee information further comprises payee category information.

11. A simplified bill paying method transacted between a customer and a financial institution, comprising:
the customer determining payees to be included in the method;
the financial institution providing to the customer a form with one listing per selected payee, including at least the payee name and a designated area to carry an amount to be paid to at least one such payee, and further comprising categorizing payees into budget categories, and indicating such on the form;
adding into one or more of the areas the one or more amounts to be paid to the appropriate payees, wherein the adding step may be accomplished at least in part by the customer, and is accomplished at least in part by being printed on the form by the financial institution;
in response to the filled-in amounts, at the direction of the financial institution, accomplishing the correct funds transfer to the appropriate payees; and
after accomplishing the funds transfer, the financial institution providing another form, and indicating on such form the most recent amount paid to each listed payee, wherein the new form also includes the amount paid to each listed payee year-to-date.
